(19) United States
(12) Patent Application Publication
(10) Pub. No.: US 2011/0061951 A1
(43) Pub. Date: Mar. 17, 2011

(54) Transformable Robotic Platform and Methods for Overcoming Obstacles

(76) Inventor: Ehud Gal, Reut (IL)

(21) Appl. No.: 12/881,199

(22) Filed: Sep. 14, 2010

Related U.S. Application Data
(60) Provisional application No. 61/241,972, filed on Sep. 14, 2009.

(51) Int. Cl. B62D 55/00

(52) U.S. Cl. 180/8.7

(57) ABSTRACT

A transformable robotic platform includes a main frame and a tiltable central assembly and two pairs of parallel tracks. A first pair of tracks is fixed to the main frame while a second pair of tracks is pivotable with respect to the main frame. The central assembly incorporates imaging means, designation means and operational means in a synchronized manner, thus simplifying the maneuvering of the robotic platform and the operation of its operational means by a remote operator. Tilting the central assembly as well as the second pair of tracks shifts the center of gravity of the robotic platform rearward decreasing downward gravitational force on the front end of the platform facilitating climbing over obstacles. Tilting the central assembly also provides double-sided operation and about face operation of the robotic platform without the need to perform maneuvers which flip over the entire robotic platform. The pivoting of second pair of tracks enables transformation of the robotic platform into a quasi pyramid position in order to provide a superior position for information gathering and for operation.

This patent application claims the benefit of U.S. Provisional Patent Application No. 61/241,972 filed 14 Sep. 2009.

### FIELD AND BACKGROUND OF THE INVENTION

The present invention is related to the field of robotics; more specifically the invention is related to the field of electro-mechanics for remotely controlling a transformable robotic platform with extended operational and maneuvering capabilities.

The art of robotics has increasingly developed throughout the years and many solutions have been offered by the art in order to overcome the various challenges inherent in the field. The solutions offered by the art are usually customized to the requirements for which a robotic platform is designed.

Bilateral operation capability in the field of robotics means the ability of a robotic platform to operate on two different sides with respect to the architecture of the robotic platform. This capability is sometimes referred to in the art as double-sided operation, dual-side operation, inversion, etc.

Bilateral robotic platforms are usually characterized by their ability to operate at an operational scene regardless to the orientation in which they are deployed (regardless of whether they are deployed right side up or upside down). This capability is especially essential when robotic platforms are to be thrown into hazardous environments and when robotic platforms are required to overcome obstacle which may cause them to flip over.

In general, the solutions offered by the art to provide bilateral operational capabilities for robotic platforms can be categorized as follows:

1. Flipping Mechanisms focus on flipping the entire robotic platform over when it inadvertently lands in a nonpreferred orientation. The robotic platform is usually designed to be fully operational only in a preferred orientation. Nevertheless, the robotic platform has limited operability including in nonpreferred orientation. Particularly, a flipping mechanism is operative in the nonpreferred orientation for flipping the robotic platform over to its preferred orientation. Subsequent to flipping, the robot resumes full operability.

2. Sensors Deflection provides double sided operation capability without the need to flip the entire robotic platform over. Full, or nearly full, operability is available in multiple orientations by tilting the robotic platform's sensors relative to the side on which the platform operates, via electro-mechanic mechanisms.

3. Firmware/electronics-based solutions may be used on a symmetric platform which is designed to operate in multiple orientations without engaging dedicated mechanical mechanisms, neither to flip the entire platform, nor to tilt its sensors. Firmware is used to adjust the information displayed to the operator according to the orientation of the platform and to control the signals which are provided from the operator.

One major challenge in the field of robotics is mobility, in other words, the ability to drive a robotic platform from one point to another. This allegedly simple challenge is comprised of a few challenging tasks, which can be generally categorized as follows:

(i) incorporating a driving mechanism to provide propelling power to the robotic platform;

(ii) incorporating sensors and communication systems to allow an operator to intuitively control the said driving mechanism, and

(iii) incorporating mechanisms to overcome obstacles (for example climbing and descending stairs).

Each of the three above-mentioned tasks can be addressed by various solutions. For a given robotic platform, the solutions are usually customized according to the requirements for which the platform is designed.

For instance, in order to perform task (ii), a platform designed to be controlled from a remote location (with no direct line of sight) usually incorporates imaging sensors in the platform and a wireless transceiver to transmit the information captured by the imaging sensors to a remote control station. At the remote station, the captured images are presented to an operator. Generally, such a platform also employs the wireless transceiver to receive control signals sent by the remote operator. The control signals are generally processed by the robotic platform using an on-board data processor. Another level of complexity is added to this task when the control over the platform is to be maintained during changing environmental conditions such as darkness, harsh weather, etc.

In order to facilitate efficient control, it is necessary to coordinate between different components integrated into the robotic platform allowing a remote operator to control the robot in a simple, intuitive manner. Such coordination is referred to herein as synchronization.

Many robotic platforms incorporate different components which can be roughly categorized as follows: (a) reconnaissance means which are used to orient the robotic platform relatively to its surroundings (e.g., sensors including imaging sensors, acoustic sensors); (b) operational means which can be activated towards targets which are found at the robotic platforms surroundings (e.g., nonlethal weapons such as pepper sprays, Taser® guns or lethal weapons such as guns and rifles), and (c) designation means which are used to aim the operational means towards targets detected by the reconnaissance means (e.g., laser-based designators, and sights). Most prior art robotic platforms include dedicated mechanisms and interfaces in order to enable control over each component which is incorporated into the robotic platform. This results in a complex control system, and a high level of training and expertise is required in order to simultaneously maneuver the platform and operate operational devices. The difficulty is compounded under adverse conditions and combat pressures for military robots. In addition, multiple dedicated control units become quite bulky and may not fit operational needs (for example when a robot is to be controlled by a soldier on the battle field). Controlling the robot is especially complex when synchronization is to be maintained while the robotic platform is in motion. For example, when the robot is traversing an obstacle while some of the components described above need to be aimed towards a target. The challenge of simultaneously controlling reconnaissance sensors, target designators and operational devices is addressed herein as the “Three Factor Dynamic Synchronization Challenge”.

Some publications that demonstrate the state of the art are:

Copending U.S. patent application Ser. No. 12/844,884 to Gal (Gal '884) discloses a robotic platform having a tiltable operational assembly. Gal '884 achieves Three Factor Dynamic Synchronization by incorporating reconnaissance sensors, target designators and operational devices into an operational assembly in a synchronized manner to simplify maneuvering of the robotic platform and the operation of its operational devices by a remote operator. The operational assembly of Gal '884 can be tilted backwards in order to facilitate climbing by shifting the center of gravity of the robotic platform backwards, thereby decrease downward pressure on the front end of the robotic platform. The operational assembly of Gal '884 can be used as an arm to apply pressure over an obstacle to raise its distal end from the ground while overcoming obstacles. Tilting the operational assembly also provides double-sided operation of the robotic platform without the need to flip the entire robotic platform.

Copending U.S. patent application Ser. No. 12/860,955 to Gal (Gal '955), depicts an electro-mechanism for extending the capabilities of bilateral robotic platforms and a method for performing the same. The electro-mechanism includes an orientation sensor to provide indication of the side over which a bilateral robotic platform operates and an actuator to tilt the main section of the electro-mechanism to an upright position with respect to the ground in order to maximize the performance of the components integrated therewith. The electro-mechanism also provides means to elevate information-gathering sensors to provide a superior position for information gathering with respect to the bilateral robotic platform.

Nevertheless, both copending applications (Gal '884 and Gal '955) are limited in that they can not significantly raise their operational devices (for example for operation while hiding behind a tall obstacle) and they can not traverse many extreme obstacles.

U.S. Pat. No. 6,263,989 to Won depicts an articulated tracked vehicle that has a main section, which includes a main frame, and a forward section. The main frame has two sides and a front end, and includes a pair of parallel main tracks. Each main track includes a flexible continuous belt coupled to a corresponding side of the main frame. The forward section includes an elongated arm. One end of the arm is pivotally coupled to the main frame near the forward end of the main frame about a transverse axis that is generally perpendicular to the sides of the main frame. The arm is sufficiently long to allow the forward section of the arm to extend below the main section in at least some rotational orientations of the arm, and the arm is shorter than the length of the main section. The center of mass of the main section is located forward of the rearmost point reached by the end of the arm in its pivoting about the transverse axis. The main section is contained within the volume defined by the main tracks and is symmetrical about a horizontal plane, thereby allowing inverted operation of the robot. Because the elongated arm of Won is short with respect to the main frame of the platform and contains no heavy components, position of the arm does not significantly change the balance of the platform or significantly change the location of the center of gravity of the platform.

The solution offered by Won addresses the bilateral capabilities challenge by providing a Flipping Mechanism as described above that incorporates elongated arms, which are attached to the forward section of the main frame. The main drawbacks of such a Flipping Mechanism and of a Flipping Maneuver associated therewith from an operational point of view are; (i) the need to perform the Flipping Maneuver when the platform lands on its back side delays the platform's operation; (ii) during the Flipping Maneuver, the elongated arm that extends out of the secured main frame is vulnerable to damage; (iii) the need to perform the Flipping Maneuver may jeopardize the operation of the platform when it lands near obstacles that might prevent performing the Flipping Maneuver.

Won does not also address the problem of synchronization. Furthermore, Won does not address the limitations of symmetrical bilateral operation which requires directing the sensors horizontally instead of tilting the sensors towards the desired region of interest, which is usually elevated relatively to the low profile platform.

International application PCT/IL/0800585 to Gal (Gal '585) discloses a robotic mobile platform vehicle that can be thrown into hostile or hazardous environments for gathering and transmitting information to a remotely located control station. One of the key features of the invention is that at least four imaging assemblies are mounted on the robotic platform and that the system has the processing ability to stitch the views taken by the four imaging devices together into an Omni-directional image, allowing simultaneous viewing of a 360 degree field of view surrounding the mobile platform. Another feature is that the system comprises a touch screen GUI and the robotic mobile platform is equipped with processing means and appropriate software. This combination enables the user to steer the robotic platform simply by touching an object in one of the displayed images that he wants to investigate. The robotic platform can then either point its sensors towards that object or, if so instructed, compute the direction to the object and travel to it without any further input from the user.

Gal '585 focuses on addressing task number (ii) (as described above) by providing intuitive remote control means to the platform's operator. In addition, the bilateral capability of the application may enable it to overcome certain kinds of obstacles by the fact that an inadvertent turnover of the platform does not interrupt its operation. Hence, the platform may basically roll down over obstacles. However, the platform of Gal '585 lacks the ability to actively climb obstacles such as stairs. In addition, the bilateral capability of Gal '585 is based on the symmetry of the platform and its sensors. Symmetry requires directing the sensors horizontally instead of tilting the sensors towards the desired region of interest, which is usually elevated relatively to the low profile platform.

Most prior art robotic platforms, such as those described above, are able to perform with varying degrees of success only the specific tasks for which they were designed.

It is therefore desirable to provide a bilateral robotic platform capable of traversing extreme obstacles.

It is therefore desirable to provide a bilateral robotic platform capable of significantly raising the operational devices of the platform.

It is therefore another desirable to provide a Three Factor Dynamic Synchronization between reconnaissance sensors, operational devices and target designators incorporated into a robotic platform.

It is yet further desirable to provide a robotic platform capable of operating multiple orientations when deployed without the need to flip the entire platform.

It is further desirable to provide a robotic platform capable of directing reconnaissance sensors, operational devices and target designators both horizontally and vertically towards targets in the surroundings regardless of the orientation in which the platform landed during deployment.

It is further desirable to provide a robotic platform capable of elevating reconnaissance sensors in a substantial manner.

Various objects and advantages of the invention will become apparent as the description proceeds.

### SUMMARY OF THE INVENTION

Various embodiments are possible for a bilateral robotic capable of overcoming obstacles and various methods for operating a robotic platform and overcoming obstacles are possible.

A robotic platform may include a first pair of tracks configured to propel the robotic platform bilaterally. The robotic platform may also include a second pair of tracks configured to propel the robotic platform bilaterally. The distal end of the second pair of tracks may be pivotally joined to the distal end of the first pair of tracks about an axis transverse to the direction of motion of the first pair of tracks and also transverse to the direction of motion of the second pair of tracks. The second pair of tracks may pivot around the axis. The second pair of tracks may be configured to shift the center of gravity of the robotic platform from in front of the pivoting axis to at least even with or even beyond the pivoting axis for at least one angle of pivoting of the second pair of tracks around the axis.

An embodiment of a robotic platform may also include an operational assembly. The operational assembly may include a sensor and a designator and an operational device. The sensor, designator and operational device may all be synchronized. The distal end of the operational assembly may be pivotally joined to the distal end of the first pair of tracks along the axis of pivoting of second pair of tracks. The operational assembly may be configured for tilting around the axis and the shifting of the center of mass of the robotic platform to be even with the axis of pivoting may be dependent on angle of tilting of the operational assembly in that for a given angle of pivoting of the second pair of tracks the center of gravity may remain in front of the axis of pivoting for some angles of tilting of the operational assembly and the center of gravity may shift to even with or even behind the axis of pivoting for another angles of tilting of the central assembly.

An embodiment of a robotic platform may be configured to reverse from a first operational orientation to an opposite operational orientation by tilting the operational assembly around the axis of pivoting.

An embodiment of a robotic platform may be configured to reverse from a first operational orientation to an opposite operational orientation by tilting the operational assembly and the second pair of tracks around the axis of pivoting.

In an embodiment of a robotic platform, the platform may reverse from a first operational orientation to an opposite operational orientation by pivoting of the second pair of tracks and the operational assembly around the axis.

In an embodiment of a robotic platform, the tilting of the operational assembly may be continuous over 360 degrees.

In an embodiment of a robotic platform, the first pair of tracks may be fixed in relation to a main frame of the robotic platform.

In an embodiment of a robotic platform, the first pair of tracks and the second pair of tracks may be configured to form a triangular base to raise the operational assembly.

In an embodiment of a robotic platform, the length of the first pair of tracks may be longer than the length of a main frame of the robotic platform.

In an embodiment of a robotic platform, the length of the second pair of tracks may be longer than the length of a main frame of the robotic platform.

In an embodiment of a robotic platform, the length of the first pair of tracks and the length of said second pair of tracks may each be longer than half the length of a main frame of the robotic platform.

In an embodiment of a robotic platform, the operational assembly may be articulated.

In an embodiment of a robotic platform, the operational device may include a weapon.

In an embodiment of a robotic platform, the pivoting of the second pair of tracks may be continuous over 360 degrees.

A method of overcoming an obstacle with a bilateral robotic platform may include bringing a front end of a first pair of tracks into proximity of the obstacle and shifting the center of gravity of the bilateral robotic platform away from the obstacle by pivoting a second pair of tracks around an axis. The axis of the pivoting may be perpendicular to a direction of motion of the first pair of tracks and also perpendicular to a direction of motion of the second pair of tracks. The axis of pivoting may be near the distal end of the first pair of tracks and also near the distal end of the second pair of tracks. The pivoting may be done while the front end of the first pair of tracks remains in proximity of the obstacle.

A method of overcoming obstacles may further include steadying the bilateral robotic platform with the second pair of tracks while the first pair of tracks drives up the obstacle

A method of overcoming obstacles may further include pivoting the second pair of tracks around the axis in order to move the center of gravity of the platform forward and provide more traction of the first pair of tracks on the obstacle subsequent to driving the first pair of tracks onto the obstacle.

A method of overcoming obstacles may further include pivoting the second pair of tracks around the axis to move the second pair of tracks over the obstacle.

A method of overcoming obstacles may further include driving the bilateral robotic platform towards the obstacle with the second pair of tracks.

In a method of overcoming obstacles shifting the center of mass of the platform may include shifting the center of mass of the platform at least even with the axis of pivoting.

In a method of overcoming obstacles shifting of the center of mass may include shifting the center of mass behind the axis of pivoting.

A method of raising a sensor of a bilateral robotic platform may include providing a revolute joint joining a distal end of a first pair of tracks to a distal end of a second pair of tracks. The method may also include pivoting the second pair of tracks around the revolute joint to form a pyramid structure wherein the front end of the first pair of tracks forms a first base of the pyramid structure and the front end of the second pair of tracks forms the second base of the pyramid structure and the revolute joint forms the apex of the pyramid structure. The method may also include directing the sensor by pivoting around the revolute joint an operational assembly including the sensor.

A method of reversing an operational direction of a robotic platform may include supplying a first pair of tracks and an operational assembly. The operational assembly may be configured to tilt around an axis, which is perpendicular to a direction of motion of the first pair of tracks. The method may also include tilting the operational assembly from facing in a first operational direction to face in a second operational direction.

A method of reversing an operational direction of a robotic platform may also include supplying a second pair of tracks having a direction of motion perpendicular to the axis of pivoting. The second pair of tracks may also be configured to pivot around the axis. The second pair of tracks may be pivoted into the second operational direction.

A method of reversing an operational direction of a robotic platform may also include, subsequent to pivoting of the second pair of tracks towards the new operational direction, also pivoting the first pair of tracks towards the new operational direction.

### BRIEF DESCRIPTION OF THE DRAWINGS

Various embodiments of a method and system for traversing obstacles with a robotic platform are herein described, by way of example only, with reference to the accompanying drawings, where:

FIG. 1 schematically shows a perspective view of the basic components of a preferred embodiment of a transformable robotic platform in an operational mode;

FIG. 2A schematically shows a perspective view of the external set of tracks as they are pivoted with respect to the main frame;

FIG. 2B schematically shows a perspective view of the external set of tracks as they are pivoted with respect to the main frame;

FIG. 3A schematically show a perspective view of the transformable robotic platform as it climbs a standard obstacle using a certain climbing method (as detailed in FIG. 4A-4F);

FIG. 3B schematically show a perspective view of the transformable robotic platform as it climbs an extreme obstacle using another climbing method (as detailed in FIG. 5A-5F);

FIG. 4A schematically shows a side projection of a method for overcoming standard obstacles by the transformable robotic platform;

FIG. 4B schematically shows a side projection of a method for overcoming standard obstacles by the transformable robotic platform;

FIG. 4C schematically shows a side projection of a method for overcoming standard obstacles by the transformable robotic platform;

FIG. 4D schematically shows a side projection of a method for overcoming standard obstacles by the transformable robotic platform;

FIG. 4E schematically shows a side projection of a method for overcoming standard obstacles by the transformable robotic platform;

FIG. 4F schematically shows a side projection of a method for overcoming standard obstacles by the transformable robotic platform;

FIG. 5A schematically shows a side projection of another method for overcoming extreme obstacles by the transformable robotic platform;

FIG. 5B schematically shows a side projection of another method for overcoming extreme obstacles by the transformable robotic platform;

FIG. 5C schematically shows a side projection of another method for overcoming extreme obstacles by the transformable robotic platform;

FIG. 5D schematically shows a side projection of another method for overcoming extreme obstacles by the transformable robotic platform;

FIG. 5E schematically shows a side projection of another method for overcoming extreme obstacles by the transformable robotic platform;

FIG. 5F schematically shows a side projection of another method for overcoming extreme obstacles by the transformable robotic platform;

FIG. 6 schematically shows a perspective view of the robotic platform when transformed into a quasi pyramid position;

FIG. 7 schematically shows a perspective view of a transformed robotic platform having an articulated operational assembly;

FIG. 8A schematically shows a perspective view of a pyramid position of a bilateral robotic platform having an articulated operational assembly, and

FIG. 8B schematically shows a perspective view of a pyramid position of a bilateral robotic platform having an articulated operational assembly.

FIG. 9 is a flow chart illustrating a first method of overcoming an obstacle with a dual track bilateral robotic platform.

FIG. 10 is a flow chart illustrating a second method of overcoming an obstacle with a dual track bilateral robotic platform.

FIG. 11 is a flow chart illustrating a method of raising a sensor of a bilateral robotic platform.

FIG. 12 is a flow chart illustrating a method of reversing an operational direction of a bilateral robotic platform.

### DETAILED DESCRIPTION OF THE INVENTION

For a better understanding of various embodiments of a transformable bilateral platform and to show how the same may be carried into effect, reference will now be made, purely by way of example, to the accompanying drawings. With specific reference to the drawings in detail, it is stressed that the particulars shown are by way of example and for purposes of illustrative discussion of preferred embodiments of a transformable bilateral platform only, and are presented for the purpose of providing what is believed to be the most useful and readily understood description of the principles and conceptual aspects of a transformable bilateral platform. In this regard, no attempt is made to show structural details of the invention in more detail than is necessary for a fundamental understanding of a transformable bilateral platform. From the description taken together with the drawings it will be apparent to those skilled in the art how the several forms of a transformable bilateral platform may be embodied in practice.

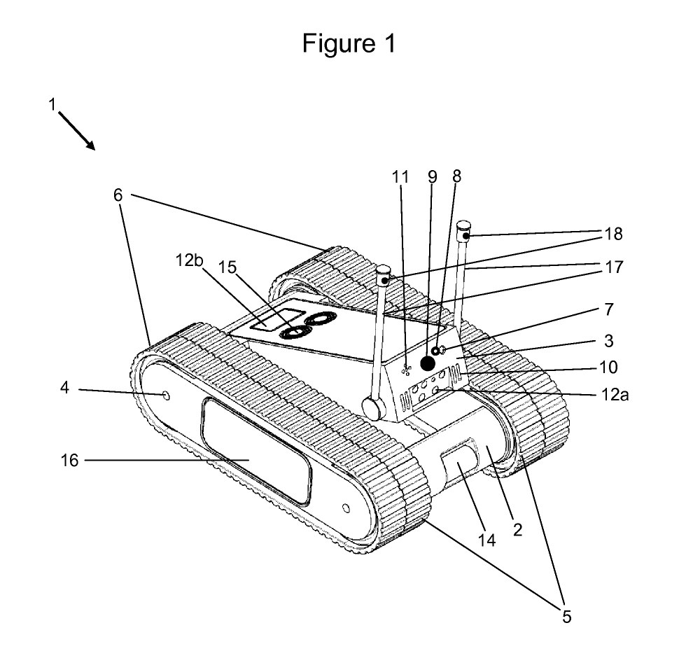

FIG. 1 schematically shows a perspective view of the basic components of a preferred embodiment of a transformable robotic platform 1 in an operational mode. Transformable robotic platform 1 includes a main frame 2 (only the front of the main frame is shown in FIG. 1) and an operational assembly 3. The distal end of operational assembly 3 is joined to main frame 2 by a revolute joint along an axis 4 which extends from one side of the main frame to the other. Axis 4 is perpendicular to the direction of motion of both a first pair 5 of tracks and a second pair 6 of tracks. In transformable robotic platform 1 operational assembly 3 is capable of complete rotation (360 degrees) around axis 4. In transformable robotic platform 1 second pair 6 of tracks is capable of complete rotation (360 degrees) around axis 4.

In an alternative embodiment two revolute joints may be incorporated one from each side of the main frame. A driving mechanism (not shown) is coupled to main frame 2 for propelling transformable robotic platform 1 by supplying driving force to first pair 5 of tracks as well as to second pair 6 of tracks. A tilting mechanism (not shown) is also coupled to the revolute joint. The tilting mechanism provides control over the inclination (tilt) of operational assembly 3 around an axis 4 with respect to main frame 2.

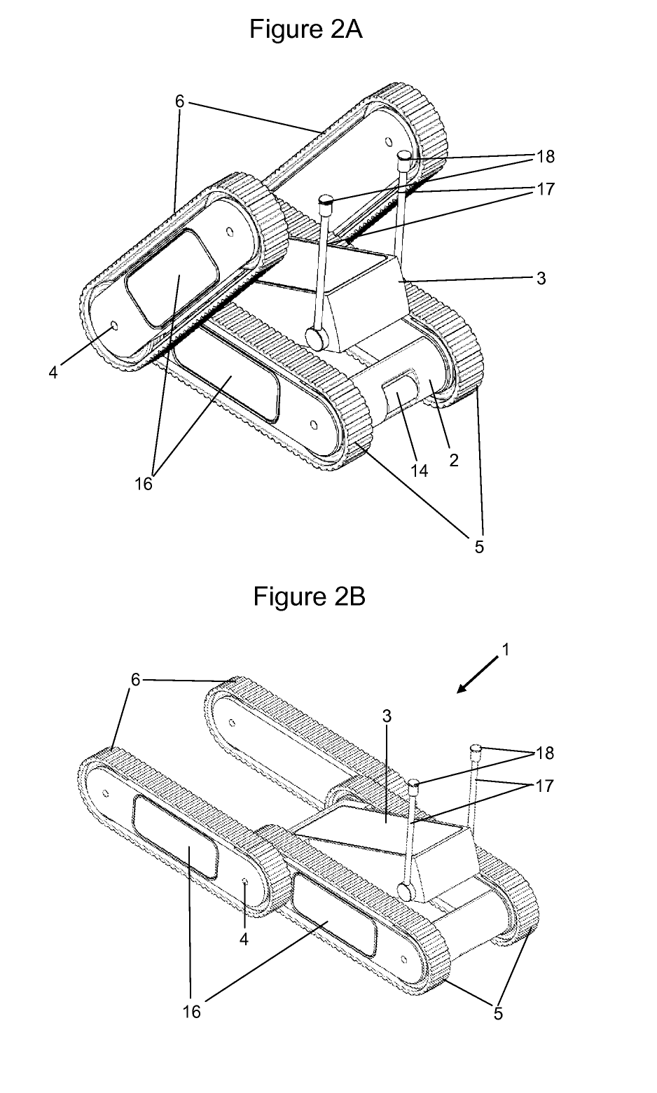

For the sake of clarity we define the distal end of main frame 2, operational assembly 3, first pair 5 of tracks, and second pair 6 of tracks as the end that is attached to axis 4. The front end of each part is then defined as that end which is opposite axis 4. As will become clear in the following, operational assembly 3 and second pair 6 of tracks pivots around axis 4 independently; such that the front ends operational assembly 3, first pair 5 of tracks and second pair 6 of tracks may face in different directions. For example, when main frame 2 and first pair 5 of tracks are horizontal and operational assembly 3 is tilted 90 degrees with respect to main frame 2 such that operational assembly 3 is vertical, then the front end of operational assembly 3 is facing upwards. Similarly, when main frame 2 and first pair 5 of tracks are horizontal and second pair 6 of tracks is pivoted 180 degrees with respect to main frame 2, then, with respect to main frame 2, the front end of second pair 6 of tracks is located behind the distal end of main frame 2 as is illustrated in FIG. 2B. We define the length of each part as the distance from the distal end of the part to its front end.

The driving mechanism of transformable robotic platform 1, includes electric motors responsible for propelling first pair 5 of tracks and second pair 6 of tracks and tilting operational assembly 3. The driving mechanism is situated inside the rear section operational assembly 3. Alternatively, the electric motors responsible for tilting operational assembly 3 and the second pair 6 of tracks may also be situated inside the rear end of the operational assembly.

In transformable robotic platform 1, the sensors and detectors (including a high resolution video camera 7), designators (including a laser pointer 8) and operational devices (including a gun 9) are organized in a synchronized manner within operational assembly 3. The high resolution video camera 7, laser pointer 8 and gun 9 are exposed and aimed in a default angle of about 30 degrees relative to main frame 2. This default 30 degrees angle focuses the sensors detectors, designators and operational devices towards the expected center of an operational scene in order to capture targets therein by the imaging sensors and in order to minimize the maneuvering commands required to point all Three Factors towards a target. This angle also provides sufficient view of the ground in order to drive the robotic platform from a remote location using a remote control unit (“Operational Mode”).

Operational assembly 3 includes sensors, detectors, designators and operational devices in a synchronized manner. For example, high resolution video camera 7 is synchronized with a laser pointer 8 which is synchronized with gun 9 which is installed inside of operational assembly 3. Because all Three Factors (i.e., the sensor, the designator and the operational device) are packed in a synchronized manner inside the operational assembly, a remote operator can easily aim all Three Factors simultaneously towards a target simply by rotating the robotic platform. From an operational point of view, the remote operator sees a video image which already includes a laser mark around the center of the image towards which the weapon system is aimed. The remote operator can point the laser mark towards a target of his choice simply by sending control signals to propel the robotic platform, thus, moving the video image with its laser mark until the laser mark is placed on the required target. When the laser mark is on the required target, the remote operator can activate the operational device towards the target by pressing a single button. This Three Factor Dynamic Synchronization facilitates the control over the robotic platform and its operational device. In other words, the same driving mechanisms which are used to propel the platform and the same reconnaissance sensors which are used to orient the remote operator are also used to aim the operational means towards targets in the surroundings, from the remote control station. Thus, the remote control station does not require dedicated interfaces to aim the operational device and the robotic platform does not require dedicated mechanisms to aim the operational device towards targets.

In transformable robotic platform 1, Three Factor Dynamic Synchronization is maintained regardless to which side the platform operates. If the platform lands on its back side during its deployment or when it inadvertently turns over while driving over an obstacle, the operator simply tilts operational assembly 3 upwards in order to enable complete functionality and synchronization as prior to the flipping of the platform. This maneuver enables double sided operation without the need perform a flipping maneuver. Tilting operational assembly 3 can be performed automatically using an orientation sensor which enables automatic upwards tilting of operational assembly 3. The image displayed on the operators control unit is also automatically flipped 180 degrees, and maneuvering signals sent by the operator are reversed so that the platform reacts to commands in an intuitive manner regardless of its orientation. In such a manner, the operator is indifferent to the side (orientation) on which the platform lands and operates.

The same principles of continuous synchronization between components integrated inside operational assembly 3 as described above can also apply to other components such as illumination LEDs 10 which illuminate field of view of high resolution video camera 7 in a wavelength suitable to the imaging sensors.

A pepper spray 11 is integrated into operational assembly 3 in order to provide a nonlethal operational means against targets. The aiming and the activation of pepper spray 11 is according to the Three Factor Dynamic Synchronization principles described above mutatis mutandis.

Transformable robotic platform 1 includes a control panel 12a on the front of operational assembly 3 and a control panel 12b on top of the operational assembly 3 for activating or deactivating transformable robotic platform 1, and to allow a local operator manual controls for switching between operational modes and for providing indication of the robotic platforms status to a local operator.

The front of the main frame 2 includes an additional set of sensors which are protected by a cover 14 and may be exposed according to operational requirements.

Operational assembly 3 includes a cooling mechanism having integrated ventilators 15 in order to disperse the heat generated by the components inside operational assembly 3.

Energy is supplied to transformable robotic platform 1 by lithium ion batteries which are stacked within second pair 6 of tracks, the batteries can be easily exchanged using openings 16 on the sides of the second pair 6 of tracks. Locating the heavy batteries in second pair 6 of tracks means that a significant portion of the weight of transformable robotic platform 1 is associated with second pair 6 of tracks. This, along with the long length of second pair 6 of tracks (the length of the entire platform) gives the operator control over the balance of transformable robotic platform 1 and the location of the center of gravity of transformable robotic platform 1. Specifically, by moving second pair 6 of tracks the operator can significantly change the location of the center of mass of transformable robotic platform 1. Some advantages of the resulting control over the balance of transformable robotic platform 1 will become clearer in the explanation that follows.

Transformable robotic platform 1 includes a submechanism for maintaining antennas 17 in an upright position regardless to the side on which the bilateral robotic platform operates. Antennas 17 are associated with a transceiver for communication. The submechanism is based on an orientation sensor which provides indication of the side on which the bilateral robotic platform is operating and sends command signals to tilt antennas 17 along with other information sensors and detectors 18 to their upright position in order to ensure maximization of the antenna performance and in order to provide a superior position from which sensors and detectors 18 may gather information with an improved viewpoint with respect to main frame 2.

FIGS. 2A and 2B schematically show perspective views of transformable robotic platform 1 in a second configuration wherein second pair 6 of tracks is pivoted with respect to main frame 2.

Second pair 6 of tracks is pivotally connected to main frame 2 via axis 4. A driving mechanism installed inside the rear end of operational assembly 3 provides the power for pivoting second pair 6 of tracks with respect to main frame 2. pivoting the second pair 6 of tracks shifts the center of gravity of transformable robotic platform 1.

In FIG. 2B, pivoting the second pair 6 of tracks 180 degrees until the front end extends behind main frame 2 extends the length of the transformable robotic platform 1 to improve its stability and its obstacle-traversing capabilities when deployed in rough terrain. It is understood that with second pair 6 of tracks extended rearward, as illustrated in FIG. 2B, the top and bottom of second pair 6 of tracks is inverted with respect to their position in FIG. 1A. Therefore, in the configuration of FIG. 1A, propelling transformable robotic platform 1 forward is achieved by driving first pair 5 of tracks forward while also driving second pair 6 of tracks forward. On the other hand, in the configuration of FIG. 1B, propelling transformable robotic platform 1 forward is achieved by driving first pair 5 of tracks forward while driving second pair 6 of tracks in reverse. In transformable robotic platform 1, a sensor reports to an on-board computer the attitude of second pair 6 of tracks (either by reporting the angle of pivot or the direction of ground contact or the tension on the tracks) to an on-board computer that takes care of adjusting the drive mechanism in order to respond properly to control signals and simplify control by the human operator.

Pivoting second pair 6 of tracks to other positions causes the rear ends of both the second pair 6 of tracks as well as first pair 5 of tracks to be raised from the ground in a manner which raises the entire transformable bilateral robotic platform 1 into a quasi pyramid position, as further detailed below.

It should be noted that, by pivoting second pair 6 of tracks as in FIG. 2B and tilting operational assembly 3 to face in the opposite direction as that shown in FIG. 2B, the operational direction of transformable robotic platform 1 can be reversed. Thus, transformable robotic platform 1 can do an almost instantaneous about face with full functionality (sensors, designators and operational means) in a reverse direction. This ability may be useful in many operational situations, for example to face an enemy who has snuck up behind transformable robotic platform 1 or in confined quarters where turning around is difficult and operation in reverse is required (for instance when trying to get in and out of tunnels or enemy bunkers, or for first clearing enemies from bunker and then turning around to face down external threats).

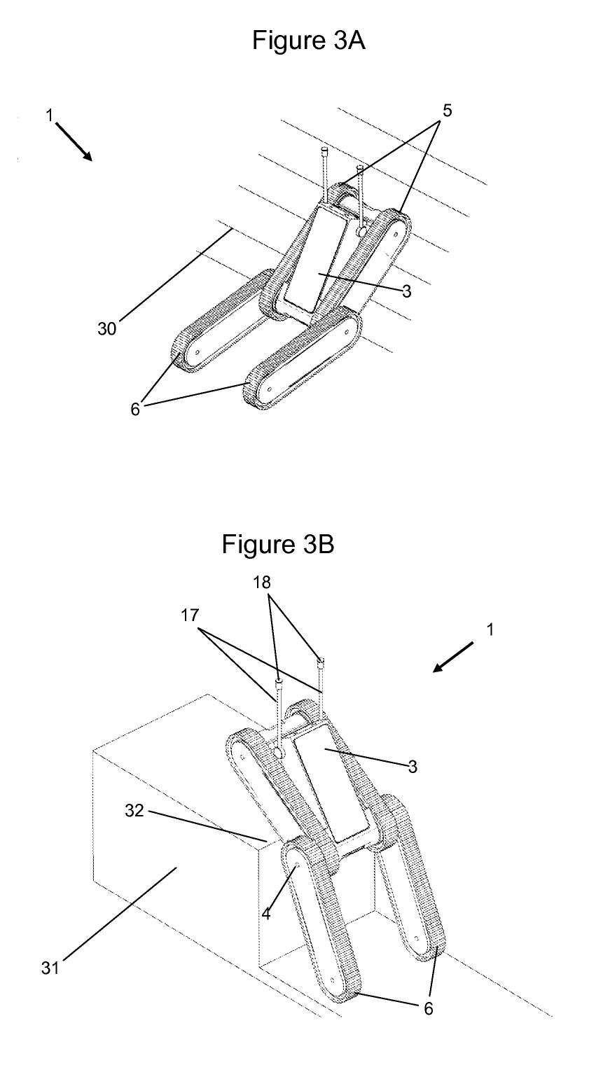

FIGS. 3A and 3B schematically show a perspective view of a method of climbing an obstacle by transformable robotic platform 1 as it climbs a standard obstacle (as shown in FIG. 3A) and a second method of climbing over an extreme obstacle (as shown in FIG. 3B).

FIG. 3A depicts transformable robotic platform 1 as it climbs a standard obstacle such as stairs 30. Second pair 6 of tracks is pivoted backwards to come in contact with the ground and to provide additional propelling power to propel transformable bilateral robotic platform 1 up stairs 30. Simultaneously, first pair 5 of tracks which are already in contact with stairs 30 pull transformable bilateral robotic platform 1 up stairs 30. Second pair 6 of tracks also provide additional support to transformable robotic platform 1 to ensure it does not slip during the climbing process especially when transformable bilateral robotic platform 1 is not perpendicular to the stairs. Due to the combined length of both first pair 5 of tracks and second pair 6 of tracks, the overall contact length between robotic platform 1 to the ground and obstacle 30 is extremely large, this ensures robust traversing of continuous obstacles such as stairs.

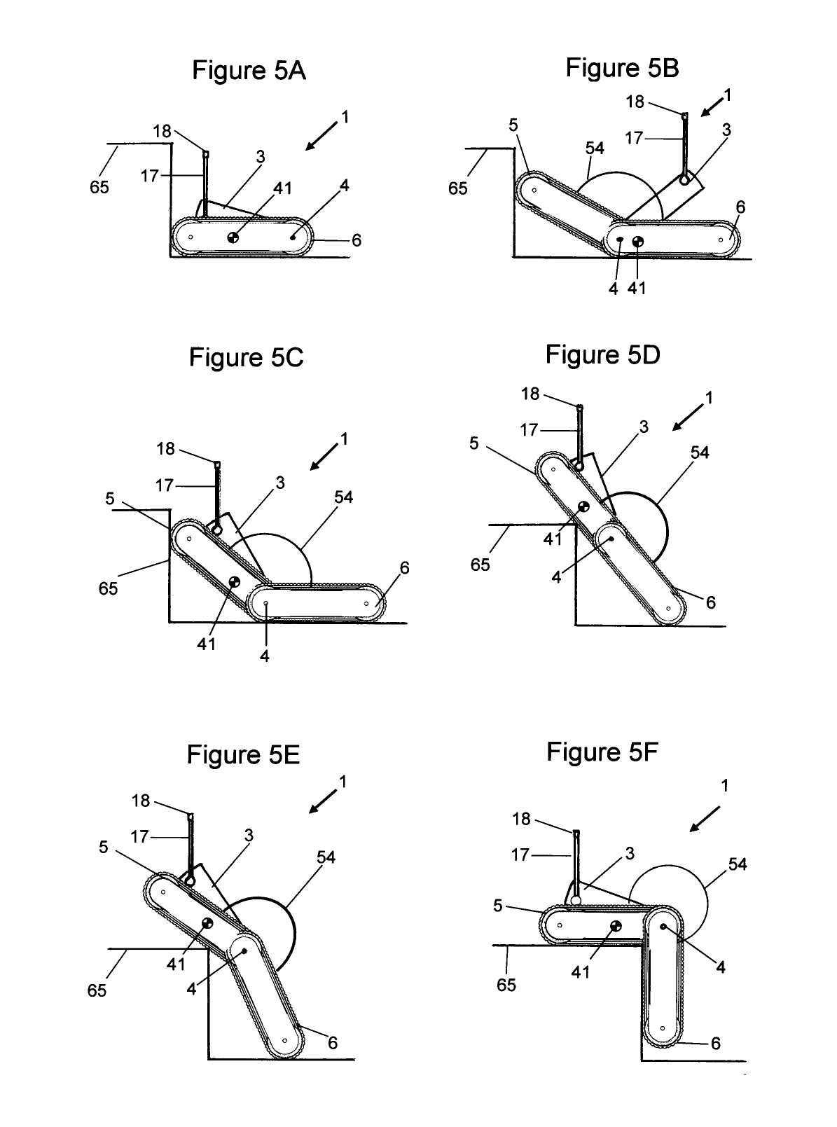

FIG. 3B depicts transformable bilateral robotic platform 1 climbing an extreme obstacle 31 by utilizing second pair 6 of tracks as support anchors while first pair 5 of tracks propel the bilateral robotic platform using the edge 32 of obstacle 31 as an anchoring surface. Details of the method are found in FIG. 5.

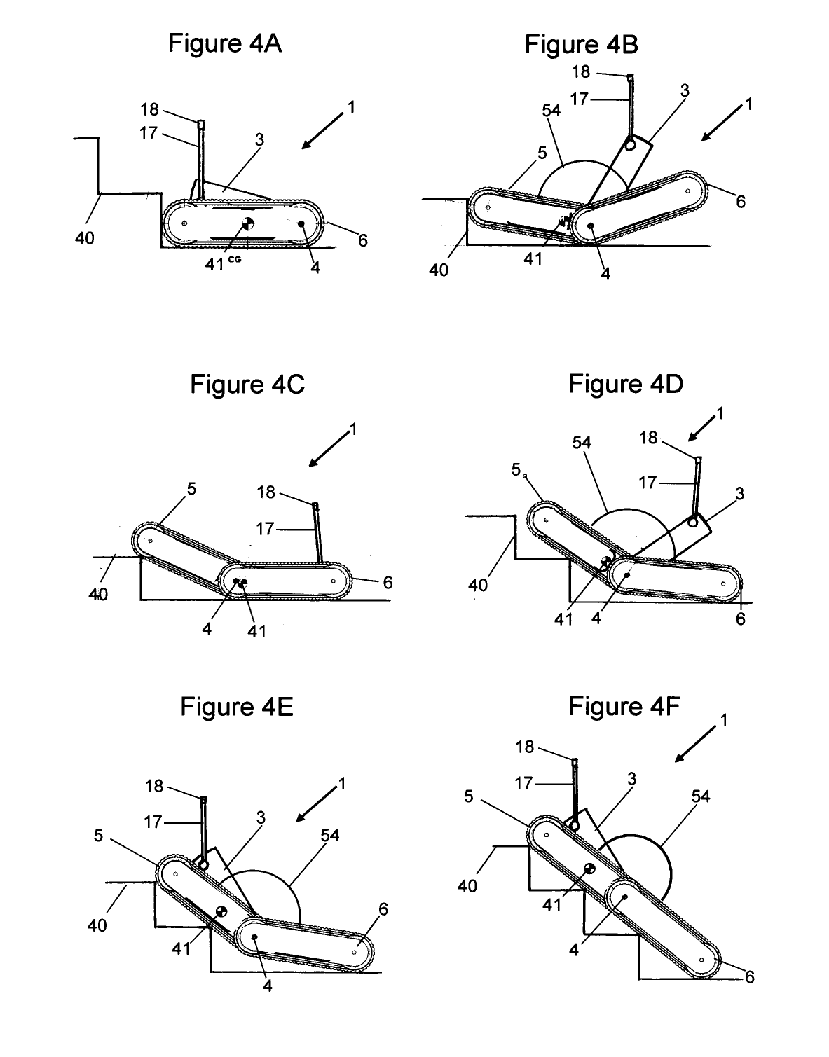

FIGS. 4A, 4B, 4C, 4D, 4E and 4F schematically show a side projection of a method for overcoming standard obstacles by the transformable robotic platform 1.

FIG. 4A depicts the positioning of transformable robotic platform 1 in front of a staircase 40. The positioning of transformable robotic platform 1 in front of staircase 40 can be either manually (i.e., the robotic platform is driven by maneuvering commands sent by an operator from a remote control unit) or automatically (i.e., based on information from sensors and detectors 18, an on-board processor recognizes staircase 40 according to predefined criteria and activates the driving mechanism to position transformable robotic platform 1 in front of the obstacle). The automation of this and of the other maneuvers described herein is based on an imaging sensor, on algorithms which analyze the captured images (image processing/image understanding), volume detectors, range detectors, ultra sound and combinations thereof.

In the configuration of FIG. 4A, the center of gravity 41 of transformable robotic platform 1 is located near the center of the main frame 2 (not visible in FIG. 4A).

FIG. 4B schematically illustrates a second step in the standard obstacle-overcoming maneuvering method. During the second step, operational assembly 3 and second pair 6 of tracks is pivoted backwards in order to shift center of gravity 41 towards the distal end main frame 2. As operational assembly 3 and second pair 6 of tracks is pivoted further backwards, angle 54 between second pair 6 of tracks and main frame 2 increases, with the effect that center of gravity 41 shifts further backwards, thereby reducing the downward force of gravity on the front end of first pair 5 of tracks.

According to the balance of transformable robotic platform 1, when operational assembly 3 and second pair 6 of tracks is pivoted far enough backwards (as shown in FIG. 5B), center of gravity 41 switches from in front of axis 4 to behind axis 4, causing the front end of first pair 5 of tracks to “float” over the ground and the front end of first pair 5 of tracks to rise off the ground. Raising the front end of first pair 5 of tracks facilitates the propelling of the front end of first pair 5 of tracks over extreme obstacle 65 and sets the platform for the next climbing steps by which first pair 5 of tracks utilizes edge of obstacle 65 as an anchoring surface.

It is emphasized that according to the second step (illustrated in FIG. 4B), even when the front end of the platform is not raised from the ground by balancing effects alone, as described in the previous paragraph, reducing the downward gravitational force on the front end of first pair 5 of tracks enables the front end of the platform to be propelled over the obstacle by slight propelling power applied by second pair 6 of tracks and first pair 5 of tracks.

The tilting of operational assembly 3 and of second pair 6 of tracks provides control over the position of the center of gravity of transformable robotic platform 1. Thereby it is also possible to perform a flipping maneuver and flip transformable robotic platform 1 over to its opposite side (nevertheless, due to the bilateral capability of transformable robotic platform 1, flipping should seldom be necessary).

Another factor which is taken into consideration in the performance of this second step is the angular velocity at which operational assembly 3 and the second pair 6 of tracks is pivoted and torque produced by their angular acceleration or deceleration. It is possible to raise the front end of the robotic platform over the obstacle by quickly decelerating the pivoting. In other words, operational assembly 3 and the second pair 6 of tracks of tracks can be swiftly pivoted backwards such that sudden stopping of the pivoting also decreases gravitational force on the front end of transformable robotic platform 1 as it is propelled over an obstacle. Then swiftly pivoting back into operational mode (illustrated in FIG. 1), will continue to help lift the front end of first pair 5 of tracks.

The choices between the different methods to perform this second step can be dictated by the nature of the obstacles to be overcome and by operational requirements. For example, the transformable robotic platform can lift the front of first pair 5 of tracks only for a short time using angular acceleration. Therefore this approach is most appropriate for relatively small obstacle. For large obstacles, balancing transformable robotic platform 1 by pivoting back second pair 6 of tracks and operational assembly 3 may be more effective. Furthermore, pivoting back second pair 6 of tracks produces additional fraction advantage, which leads to more propulsion power for overcoming difficult obstacles.

In transformable robotic platform 1, dedicated tilting mechanisms are incorporated to control the tilt of the operational assembly 3 and second pair 6 of tracks.

FIG. 4C illustrates a third step in the first method of overcoming a standard obstacle. In the third step, operational assembly 3 is further tilted backwards along with the second pair 6 of tracks. Center of gravity 41 is thereby further shifted backwards until it switches from front of axis 4 to behind axis 4 to raise the front end of the first pair 5 of tracks higher. Simultaneously, traction is applied by second pair 6 of tracks to propel transformable robotic platform 1 forward until the front end of first pair 5 of tracks climbs over the first step of staircase 40. Once over the first step first pair 5 of tracks also take part in the propulsion of transformable robotic platform 1 further up the stairs.

FIG. 4D illustrates a fourth step in the first method of overcoming a standard obstacle. During the fourth step, operational assembly 3 is tilting back to operational mode. Torque is applied along axis 4 between first pair 5 of tracks and second pair 6 of tracks to raise the distal end of main frame 2 from the ground. Traction of first pair 5 of tracks on the first step of staircase 40 as well as traction of the front end of second pair 6 of tracks on the ground propel transformable robotic platform 1 forward and upward.

In transformable robotic platform 1, angle 54 between the first pair 5 of tracks and second pair 6 of tracks is controlled via a dedicated tilting mechanism, which produces an appropriate torque. Angle 54 is automatically adjusted in order to divide effectively the traction applied by both first pair 5 of tracks to the second pair 6 of tracks during the climbing process. Automatic adjustments of angle 54 is performed using a set of sensors and an algorithm which takes into account the angle of both first pair 5 of tracks to the second pair 6 of tracks relative to the ground and the balance of gravitational forces and forces between both first pair 5 of tracks to the second pair 6 of tracks and the ground. Imaging sensor data are also to be utilized in analyzing the position of transformable robotic platform 1 relative to staircase 40, in order to activate the tilting mechanism to enhance the obstacle-overcoming capabilities.

Similar mechanisms are also to be utilized in order to maintain front end of first pair 5 of tracks facing the front of staircase 40 and thus avoiding drifting off the obstacle during the climbing process. Lateral drift is negated by differentiating the propelling power supplied traction on the right side of the robotic platform in relation to the propelling power supplied traction on the left side of the robotic platform.

FIG. 4E illustrates a fifth step in the first method of overcoming a standard obstacle. During the fifth step, operational assembly 3 now in operational mode, antennas 17 are held vertically aloft to maximize communication performance and sensors and detectors 18 are directed towards the operational scene.

Angle 54 between first pair 5 of tracks to second pair 6 of tracks is increased in order to increase traction. Thus, the dedicated tilting mechanism applies torque increasing angle 54 in order to raise the distal end of the main frame from the ground such that additional fraction will be applied on higher contact surfaces.

FIG. 4F illustrates a sixth step in the first method of overcoming a standard obstacle. During the sixth step, angle 54 between the main frame and first pair 5 of tracks to second pair 6 of tracks has been increased to 180 degrees. Thus, transformable robotic platform 1 is elongated substantially with respect to the compact configuration illustrated in FIG. 1. Elongation increases the contact surfaces between first pair 5 of tracks, second pair 6 of tracks, the ground and the obstacle being overcome. Increasing contact surfaces increases the stability of the transformable robotic platform 1 during the climbing process. During the sixth step, fraction is proportionally applied over four different contact surfaces (the right and left tracks of both first pair 5 of tracks and second pair 6 of tracks) giving exceptional traversability to transformable robotic platform 1.

FIGS. 5A, 5B, 5C, 5D, 5E and 5F schematically show a side projection of second method for overcoming extreme obstacles by transformable robotic platform 1.

FIG. 5A illustrates a first step of the second method for overcoming obstacles. During this first step, transformable robotic platform 1 is being moved in front of an extreme obstacle 65 which is to be overcome.

FIG. 5B illustrates a second step of the second method for overcoming obstacles. During this second step the, operational assembly 3 is tilted backwards using a dedicated tilting mechanism. The second pair 6 of tracks is also pivoted backwards using another dedicated tilting mechanism until second pair 6 of tracks comes in contact with the ground. In this position, the center of gravity 41 of the robotic platform has shifted backwards until it switched from the front of axis 4 to behind axis 4. Moving center of gravity 41 behind axis 4 beyond the end of main frame 2 enables lifting of the front end of first pair 5 of tracks and main frame 2 of transformable robotic platform 1.

During these maneuvers antennas 17 are kept vertical to maximize communication performance and to maximize the view of sensors and detectors 18.

FIG. 5C illustrates a third step in the second method for overcoming obstacles. During this third step, operational assembly 3 has been returned into operational mode position. Thus, the center of gravity 41 of transformable robotic platform 1 has been shifted forward in front of axis 4, to increase the traction between the first pair 5 of tracks to extreme obstacle 65 and to maintain the readiness of the platform to engage threats which it may face beyond obstacle 65 as provided by the operational mode position.

Angle 54 between the first pair 5 of tracks and second pair 6 of tracks is adjusted to divide traction between first pair 5 of tracks and second pair 6 of tracks. Thus, first pair 5 of tracks as well as second pair 6 of tracks apply coordinated propelling power over obstacle 65 and the ground.

FIG. 5D illustrates a fourth step in the second method for overcoming obstacles. During this fourth step, angle 54 is set at 180 degrees in order to elongate the overall length of transformable robotic platform 1. With operational assembly 3 forward in the operational mode, the center of gravity 41 of transformable robotic platform 1 is shifted beyond the edge of extreme obstacle 65. Once center of gravity 41 is located over extreme obstacle 65, the leading edge extreme obstacle 65 is utilized as an anchoring surface over which first pair 5 of tracks propels transformable robotic platform 1. In this position, traction between second pair 6 of tracks and the ground steadies transformable robotic platform 1 and ensures that transformable robotic platform 1 does not slide off the obstacle. Second pair 6 of tracks also assists the forward and upward propulsion of transformable robotic platform 1 over extreme obstacle 65.

FIG. 5E illustrates a fifth step of the second method for overcoming obstacles. During this fifth step, angle 54 is further increased bringing second pair 6 of tracks towards the obstacle such that center of gravity 41 is moved forward and first pair 5 of tracks and main frame 2 rest on extreme obstacle 65 thus increasing the contact surface between first pair 5 of tracks and extreme obstacle 65. First pair 5 of tracks further propel transformable robotic platform 1 moving center of gravity 41 of transformable robotic platform 1 further forward over top of extreme obstacle 65.

FIG. 5F illustrates a sixth step in the second method of overcoming an obstacle. Once first pair 5 of tracks is in full contact with the top of extreme obstacle 65 and center of gravity 41 is over the top of obstacle 65, second pair 6 of tracks is pivoted from their vertical position (shown in the figures) over the top of axis 4 back into operational mode position (as illustrated in FIG. 1) and transformable robotic platform carries on with its mission.

An operator chooses the first or the second method described above to overcome an obstacle according to the nature of the obstacle to be overcome and according to operational requirements. For example, when facing a staircase, the first method can provide continuous maneuvering while climbing the staircase. The second method however can provide more torque to overcome a relatively large obstacle.

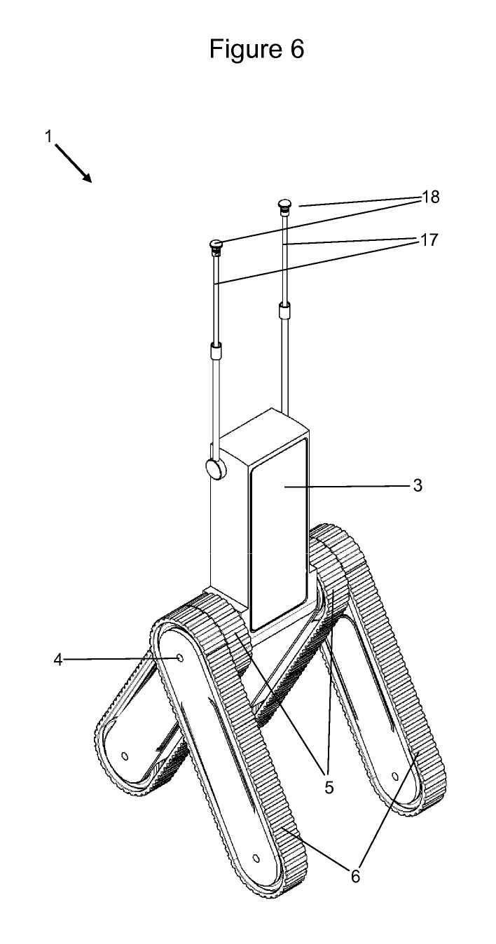

FIG. 6 schematically shows a perspective view of transformable robotic platform 1 when transformed into a quasi pyramid position.

In a preferred embodiment, transformable robotic platform 1 is transformed into a pyramid position by first operating a tilting mechanism (that provides torque between second pair 6 of tracks and main frame 2 around axis 4) pivoting second pair 6 of tracks 180 degrees, thus inverting second pair 6 of tracks until the top of second pair 6 of tracks contacts the ground (as illustrated in FIG. 2B). The tilting mechanism continues to apply torque, pushing the front end of second pair 6 of tracks (which is behind main frame 2) and the front end of first pair 5 of tracks (which is located at the front of main frame 2) against the ground and using traction to drive the front end of second pair 6 of tracks and the front end of first pair 5 of tracks together to create the base of the pyramid, thereby lifting the axis 4 off the ground. When the desired configuration is achieved, the torque between second pair 6 of tracks and main frame 2 is stopped.

In a preferred embodiment of the present invention, during the creation of the base of the pyramid or thereafter, the operational assembly 3 is tilted vertical with respect to the base of the pyramid using a tilting mechanism. The pyramid position enables significant elevation of operational assembly 3, thus providing a superior position from which information can be gathered and from which the operational means of the robotic platform can be activated. Operational assembly 3 can, of course, be tilted towards regions of interest while in the pyramid position by tilting of operational assembly 3 around axis 4 such that the Three Factor Dynamic Synchronization principle is maintained while in the pyramid position.

Traction can be used to propel transformable robotic platform 1 while in the pyramid position.

In transformable robotic platform 1, antennas 17 and sensors and detectors 18 also tilt to a vertical position and extend to provide further elevation in order to improve wireless communication reception between the bilateral robotic platform to a remote operator, to gather information from a superior position, to raise sensors and detectors 18 over obstacles (for example while transformable robotic platform 1) is hidden behind an obstacle.

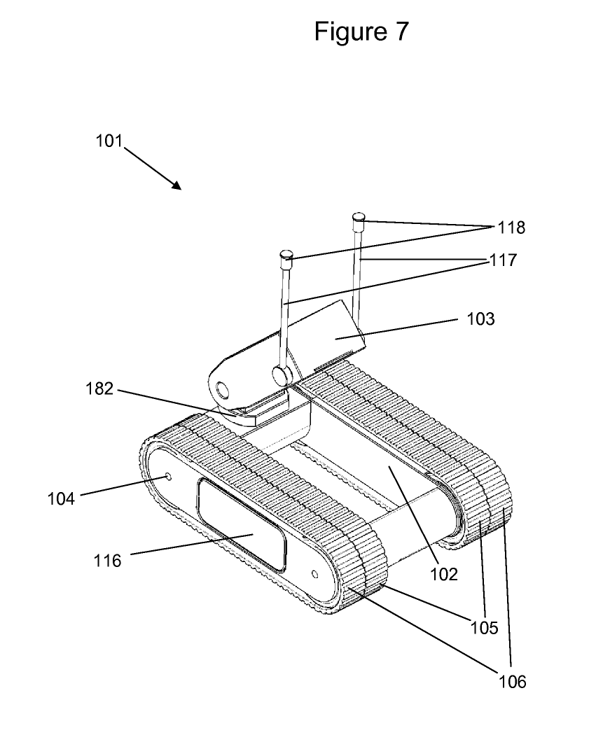

FIG. 7 schematically shows a perspective view of an embodiment 101 of a bilateral robotic platform having an articulated operational assembly 103, a main frame 102, a axis 104, first pair 105 of tracks, second pair 106 of tracks, antennas 117, and sensors and detectors 118.

In second preferred embodiment, an operational assembly 103 is pivotally connected to a main frame 102 by a revolute joint via a universal joint 182.

In embodiment 2, the robotic platform can switch into “Exploring Mode” according to which the operational assembly 103 is tilted and traversed according to commands sent by a remote operator in order to investigate regions of interest of the remote operator's choice. The articulation of operational assembly 103 enables the investigation of regions of interest all around the robotic platform's surroundings while eliminating the need to rotate the entire robotic platform.

In embodiment 2, universal joint 182 includes a slip ring mechanism to supply power and communication connections between operational assembly 103 and main frame 102 while providing continuous 360 degree tilting of the operational assembly 103 in either direction without tangling wires. Alternatively, the operational assembly 103 and the main frame 102 may include separable power supplying units and communicate over wireless channels in order to eliminate the need to incorporate a slip ring mechanism into embodiment 2.

Because all of the synchronized components are harnessed within operational assembly 103, tilting and traversing operational assembly 103 via a revolute joint and universal joint 182 enables synchronized imaging, pointing and aiming towards regions of interest and targets which are located all around the operational scene with respect to the robotic platform. Thus, embodiment 2 also has undisrupted synchronization according to the Three Factor Dynamic Synchronization principle described above.

In embodiment 2, detachable side panels 116 on second pair 106 of tracks enables rapid exchange of lithium ion batteries which supply the power to the robotic platform. The batteries add weight to second pair 106 of tracks. Adding weight to second pair 106 of tracks balances the weight of the robotic platform between second pair 106 of tracks, operational assembly 103 and main frame 102. Thus, using the independent motility second pair 106 of tracks, operational assembly 103 and main frame 102, the operator of the robotic platform has flexibility in positioning the center of gravity on either side of axis 104 when overcoming obstacles.

In embodiment 2, the robotic platform incorporates water resistant techniques which enable the robotic platform to maintain stable operational capabilities during harsh weather or when traversing puddles, mud, etc.

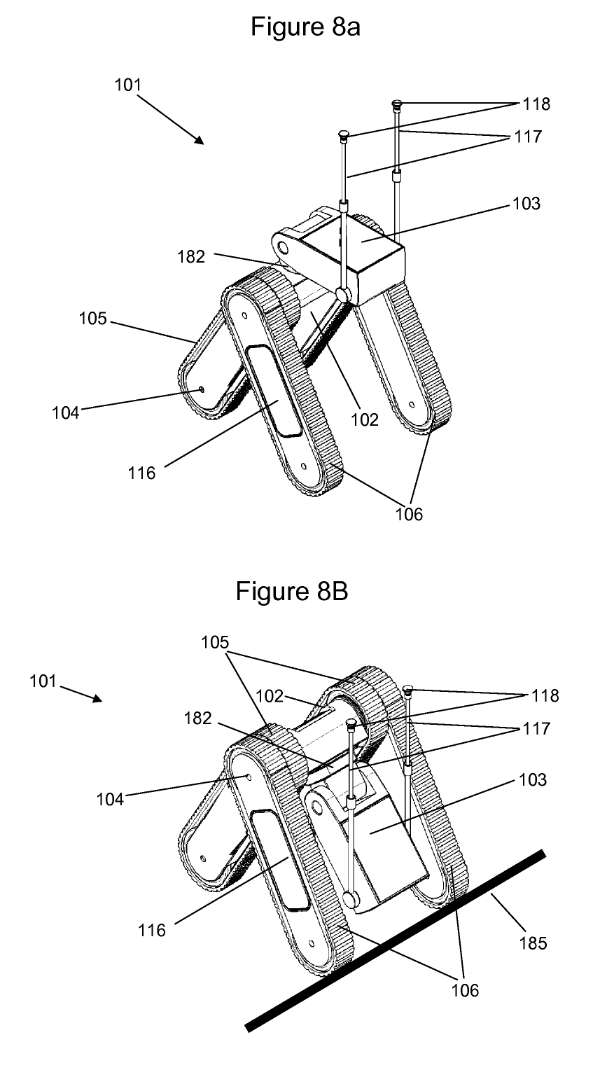

FIGS. 8A and 8B schematically show a perspective view of a pyramid position of embodiment 2.

FIG. 8A depicts embodiment 2 in a pyramid position while articulated operational assembly 103 is switched to exploring mode for scanning the surroundings and gathering information from a superior viewpoint (i.e., from the elevated location of operational assembly 103 on top of the base pyramid). Scanning over 306 degrees is accomplished without the need to rotate the pyramid but rather by tilting and rotating articulated operational assembly 103. This configuration supports the Three Factor Synchronization principle.

FIG. 8B depict another possible, position by which operational assembly 103 is tilted in order to gather information while activating operational means towards an object 185 which is on the ground underneath the bilateral robotic platform.

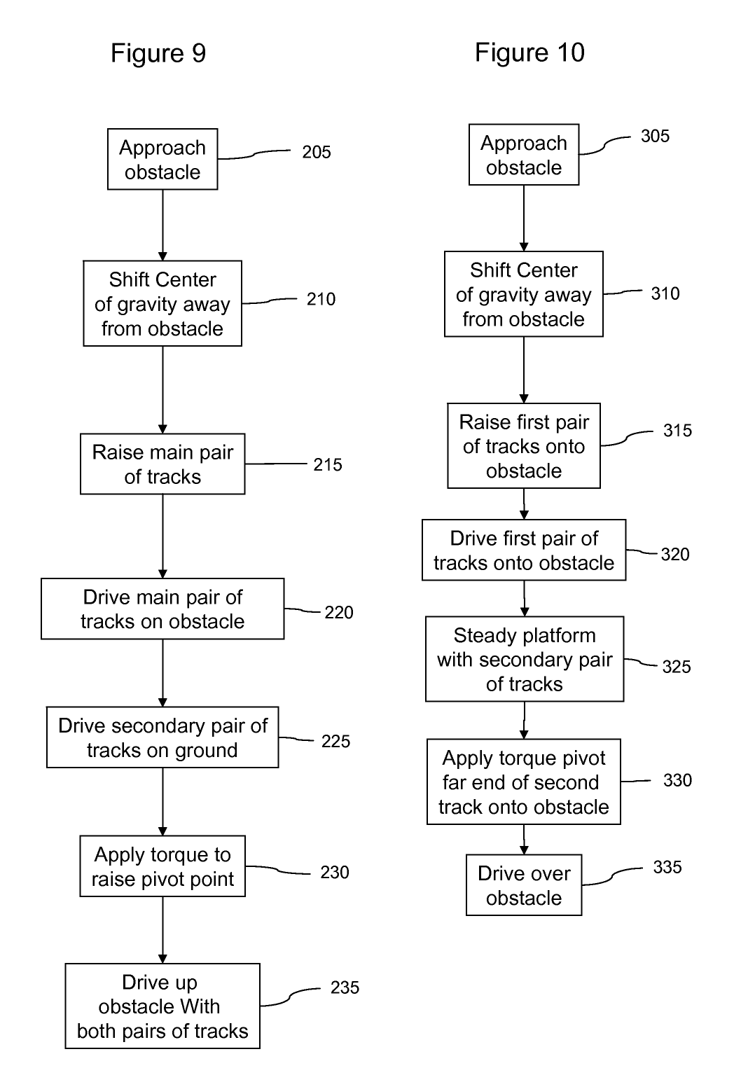

FIG. 9 is a flow chart illustrating a first method of overcoming an obstacle the method is also illustrated in schematically in FIGS. 4A-F. First transformable robotic platform 1 approaches 205 an obstacle as illustrated in FIG. 4A. As detailed above in the explanation of FIG. 4A, approaching 205 may be through direct commands or by an automatic algorithm.

Once transformable robotic platform 1 has reached the obstacle, transformable robotic platform 1 shifts 210 its center of gravity 41 backwards making it easier to raise the front end of transformable robotic platform 1. For example as illustrated in FIG. 4B transformable robotic platform 1 shifts 210 its center of gravity 41 by pivoting second pair 5 of tracks and operational assembly 3 rearward while the front end of first pair 5 of tracks remains in place next to the obstacle.

Shifting 210 center of gravity 41 away from the obstacle makes it easier to raise 215 first pair 5 of tracks as illustrated in FIGS. 4B, 4C and 4D. When center of gravity 41 is shifted far enough backwards, beyond axis 4, which is the end of the base of main frame 2, the front end of main frame 2 is raised spontaneously off the ground due to the balance of gravitational forces.

Once first pair 5 of tracks has been raised and are floating the operator drives 220 first pair of tracks on the obstacle and also drives 225 second pair 6 of tracks on the ground, propelling transformable robotic platform 1 up the obstacle as illustrated in FIG. 4C. Second pair 6 of tracks also serves to steady transformable robotic platform 1 so that first pair 5 of tracks will not slip off of the obstacle.

Then torque is applied along joint 4 between first pair 5 of tracks and second pair 6 of tracks to raise joint 4 and the front end of second pair 6 of tracks as illustrated in FIGS. 4D and 4E. Torque may also be applied to tilt operational assembly 3 back into operational mode position as shown in FIG. 4E and FIG. 4F such that transformable robotic platform 1 is ready to engage threats during the obstacle overcoming and immediately thereafter.

Finally, transformable robotic platform 1 is driven up the obstacle using all tracks as illustrated in FIG. 4F.

FIG. 10 is a flow chart illustrating a second method of overcoming an obstacle 65 with transformable robotic platform 1. The method is also illustrated schematically in FIGS. 5A-F. First, transformable robotic platform 1 approaches 305 obstacle 65 with the front end of first pair 5 of tracks as illustrated in FIG. 5A.

Once transformable robotic platform 1 has reached obstacle 65, transformable robotic platform 1 shifts 310 its center of gravity 41 backwards until center of gravity switches its position, from in front of axis 4 to behind axis 4, making it easier to raise the front end of transformable robotic platform 1. For example as illustrated in FIG. 5B transformable robotic platform 1 shifts 310 its center of gravity 41 by pivoting second pair 5 of tracks and operational assembly 3 rearward while the front end of first pair 5 of tracks remains in place next to obstacle 65. The combined weight of second pair 6 of tracks and operational assembly 3 is a large portion of the total weight of transformable robotic platform 1. Furthermore the length of second pair 6 of tracks is as long as the length of main frame 2 therefore by pivoting both second pair 6 of tracks and operational assembly 3 behind the distal end of main frame 2, center of gravity 41 has been shifted to beyond axis 4 (behind the distal end of first pair 5 of tracks and behind the distal end of main frame 2).

Shifting 310 center of gravity 41 away from obstacle 65 makes it easier to raise 315 first pair 5 of tracks as illustrated in FIG. 5B. Even more so, because center of gravity 41 has shifted beyond axis 4 (behind the distal end of first pair 5 of tracks and behind the distal end of main frame 2), it is possible to lift entire main frame 2 up off the ground shifting all of the weight of transformable robotic platform 1 onto second pair 6 of tracks. Thus, when transformable robotic platform 1 gets stuck, it can pivot secondary tracks and away from main frame 2 and figuratively pick itself up by its own bootlaces, lifting the entire main frame up off the ground onto second pair 6 of tracks. This ability gives transformable robotic platform 1 a significant operational advantage when it gets stuck in mud, holes, or in tight locations without maneuvering room. In fact by repeatedly using this maneuver transformable robotic platform 1 can roll itself along without use of traction at all.

First pair 5 of tracks is then driven 320 onto obstacle 65 using traction of first pair 5 of tracks and second pair 6 of tracks as illustrated in FIG. 5C. Second pair 6 of tracks is also used to steady transformable robotic platform 1 as illustrated in FIGS. 5D, 5E and 5F.

Once center of gravity 41 is completely over the top of obstacle 65, second pair 6 of tracks is pivoted counter clockwise over the top of axis 4 and obstacle 65.

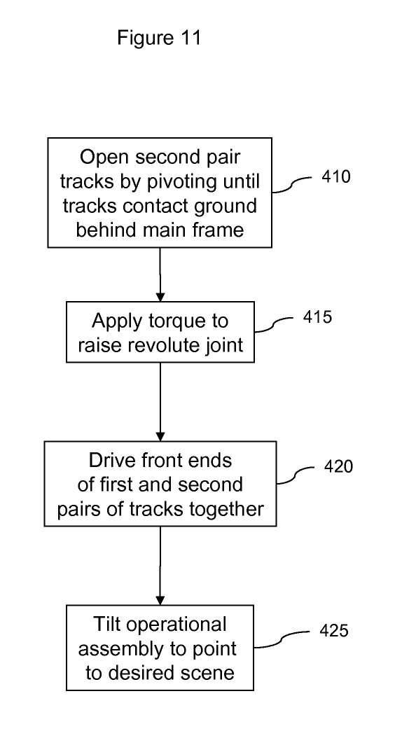

FIG. 11 is a flow chart illustrating a method of raising sensors to an improved vantage point according to the schematic illustration of FIGS. 6, 8A and 8B. First second pair 6 of tracks is opened 410 until they contact the ground as illustrated in FIG. 2B. Then Torque is applied 415 along axis 4 to raise the distal ends of first pair 5 of tracks and second pair 6 of tracks off the ground. Traction is also used to drive 420 the front ends of first pair 5 of tracks and second pair 6 of tracks together further raising distal ends of first pair 5 of tracks and second pair 6 of tracks off the ground.

This results in the upright triangle pyramid configuration of FIGS. 6, 8A and 8B with axis 4 at the apex. Operational assembly 3 (or alternatively operational assembly 103) which is attached to axis 4 is now held at the apex of the pyramid and is tilted around axis 4 to get an optimal view of the operational scene as illustrated in FIGS. 6, 8A and 8B.

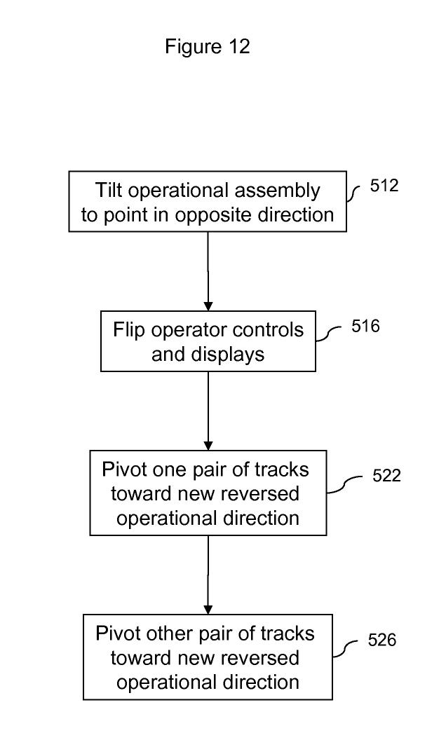

FIG. 12 is a flow chart illustrating a method of reversing an operational direction of transformable robotic platform 1 (performing an about face without propelling the platform). The operational direction is reversed by tilting 512 operational assembly 3 from facing in a first operational direction to face in a second operational direction. Since the tilting also flips over operational assembly, therefore the operator controls and display are automatically flipped 516 in order that control of transformable robotic platform 1 remains intuitive.

Tilting 512 of operational assembly 3 to perform an about face may be performed when transformable robotic platform is in the extended traction mode as depicted in FIG. 2B. In that case, in the resulting reversed operational direction, operational assembly 3 extends back over second pair 6 of tracks.

Tilting 512 of operational assembly 3 to perform an about face may be performed when transformable robotic platform 1 is in the operational mode as depicted in FIG. 1. In that case, in the resulting reversed operational direction, operational assembly 3 extends back behind both pairs of tracks. In that case, to improve stability, either first pair 5 or second pair 6 of tracks may also be pivoted 522 toward the new reversed operational direction.

Subsequently, once transformable bilateral platform 1 is in the extended fraction mode, the other track. (which is not facing toward the current operational direction) may be pivoted 526 toward the current operational direction putting transformable robotic platform 1 into operational mode (as depicted in FIG. 1) in the new reversed operational direction.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1) A robotic platform comprising:
A) a first pair of tracks configured to propel the robotic platform bilaterally;
B) a second pair of tracks configured to propel the robotic platform bilaterally, a distal end of said second pair of tracks pivotally joined to a distal end of said first pair of tracks about an axis transverse to a direction of motion of said first pair of tracks and also transverse to a direction of motion of said second pair of tracks allowing pivoting of said second pair of tracks about said axis, and wherein said second pair of tracks are configured for shifting a center of gravity of the robotic platform from in front of said pivoting axis back to at least even with said pivoting axis.

2) The robotic platform of claim 1 further comprising:
C) an operational assembly including a sensor, a designator and an operational device said sensor being synchronized to said designator and said sensor also being synchronized to said operational device, and a distal end of said operational assembly being pivotally joined to said distal end of said first pair of tracks, said operational assembly being configured for tilting around said axis and said shifting depends on an angle of said tilting of said operational assembly.

3) The robotic platform of claim 2 wherein said robotic platform is configured to reverse from a first operational orientation to an opposite operational orientation by tilting said operational assembly around said axis.

4) The robotic platform of claim 2 wherein said robotic platform is configured to reverse from a first operational orientation to an opposite operational orientation by tilting said operational assembly and said second pair of tracks around said axis.

5) The robotic platform of claim 2 wherein said operational assembly is configured for said tilting continuously over 360 degrees.

6) The robotic platform of claim 1 wherein said first pair of tracks is fixed in relation to a main frame of the robotic platform.

7) The robotic platform of claim 1 wherein said first pair of tracks and said second pair of tracks are configured to form a triangular base to raise said operational assembly.

8) The robotic platform of claim 1 wherein a length of said first pair of tracks is longer than a length of a main frame of the robotic platform.

9) The robotic platform of claim 1 wherein a length of said second pair of tracks is longer than a length of a main frame of said robotic platform.

10) The robotic platform of claim 1, wherein a length of said first pair of tracks and a length of said second pair of tracks are each longer than half a length of a main frame of the robotic platform.

11) The robotic platform of claim 1 wherein said operational assembly is articulated.

12) The robotic platform of claim 1 wherein said operational device includes a weapon.

13) The robotic platform of claim 1 wherein said second pair of tracks is configured for said pivoting continuously over 360 degrees.

14) A method of overcoming an obstacle with a bilateral robotic platform comprising:
A) bringing a front end of a first pair of tracks into proximity of the obstacle, and
B) shifting a center of gravity of the bilateral robotic platform away from the obstacle by pivoting a second pair of tracks around an axis, said axis perpendicular to a direction of motion of said first pair of tracks and perpendicular to a direction of motion of said second pair of tracks; said pivoting while said front end of said first pair of tracks remains in proximity of the obstacle.

15) The method of claim 14 further comprising:
C) steadying the bilateral robotic platform with said second pair of tracks while driving said first pair of tracks up the obstacle

16) The method claim 15 further comprising:
C) pivoting said second pair of tracks around said axis to move said center of gravity forward, said pivoting subsequent to said shifting and said driving.

17) The method claim 14 further comprising:
C) pivoting said second pair of tracks around said axis to move said second pair of tracks over said obstacle.

18) The method claim 14 further comprising:
C) driving the bilateral robotic platform towards the obstacle with said second pair of tracks.

19) The method of claim 14 wherein said shifting of said center of mass includes shifting said center of mass from in front of said axis back to at least even with said axis.

20) The method of claim 14 wherein said shifting of said center of mass includes shifting said center of mass behind said axis.

21) A method of raising a sensor of a bilateral robotic platform comprising:
A) providing a revolute joint joining a distal end of a first pair of tracks to a distal end of a second pair of tracks;
B) pivoting said second pair of tracks around said revolute joint to form a pyramid structure wherein a front end of said first pair of tracks forms a first base of said pyramid structure and a front end of said second pair of tracks forms a second base of said pyramid structure and said revolute joint forms an apex of said pyramid structure, and
C) directing the sensor by pivoting around said revolute joint an operational assembly including the sensor.

22) A method of reversing an operational direction of a robotic platform comprising:
A) supplying a first pair of tracks and an operational assembly, said operational assembly configured to tilt around an axis, said axis perpendicular to a direction of motion of said first pair of tracks, and
B) tilting said operational assembly from facing in a first operational direction to face in a second operational direction.

23) The method of claim 22 further comprising:
C) supplying a second pair of tracks, a direction of motion of said second pair of tracks being perpendicular to said axis, said second pair of tracks being configured to pivot around said axis, and
D) pivoting said second pair of tracks toward said second operational direction.

24) The method of claim 23 further comprising:
E) subsequent to said pivoting of said second pair of tracks, pivoting said first pair of tracks towards said second operational direction.
